(19) United States
(12) Patent Application Publication
(10) Pub. No.: US 2010/0127081 A1
(43) Pub. Date: May 27, 2010

(54) TARGETING SCHEME FOR DATAFORM READERS

(75) Inventor: Sean P. Kearney, Marlton, NJ (US)

Correspondence Address: HONEYWELL/PERKOWSKI;Patent Services, 101 Columbla Road, P.O.Box 2245, Morristown, NJ, 07962, US

(73) Assignee: Metrologic Instruments, Inc., Blackwood, NJ (US)

(21) Appl. No.: 12/277,827

(22) Filed: Nov. 25, 2008

(51) Int. Cl. G06K 7/10

(52) U.S. Cl. 235/462.22

(57) ABSTRACT

In a handheld dataform reader, the usability of the reader is greatly enhanced by monitoring the distance between the dataform reader and the surface bearing a symbol to be read and then changing the dataform reader's targeting image's visual characteristics from one state to another state when the distance between the dataform reader and the surface bearing the symbol is within a predefined optimal focus range of the reader, thus, alerting the user that the dataform reader can be triggered to read the symbol.

### FIELD OF THE INVENTION

The present invention relates to dataform readers such as barcode readers.

### BACKGROUND

Handheld dataform readers such as imager type symbol readers (also referred to as imager scanners) typically utilize a visible light image (targeting image) projected into the scan field to show the user the center of the reader's field of view. The targeting images are generally generated by an LED or laser provided in the imager reader. The targeting image allows the user to properly align and center the symbols (e.g. a barcode, a produce look-up codes (PLC), etc.) in the reader's field of view by positioning the handheld reader over the symbol so that the targeting image is projected on the symbol. However, this conventional targeting scheme does not give the user the ability to determine the optimal focus distance (also referred to as best scanning\highest scanner aggression distance) for the imager reader so that the imager reader can be triggered to take a reading. The user must try taking a reading at an arbitrarily chosen distance to see whether the reader can successfully read the symbol at a particular distance. If not, the user must try taking another reading at a different distance until the reader is able to read the barcode.

### SUMMARY

According to an embodiment, a method for use with a dataform reader that utilizes a targeting image projected into the dataform reader's scan field comprises bringing a surface bearing a symbol within the scan field and monitoring the distance between the dataform reader and the surface bearing the symbol using a ranging means provided in the dataform reader. Then, as the user moves the reader and changes the distance between the reader and the surface bearing the symbol, a visual characteristic of the targeting image is changed when the distance between the dataform reader and the surface bearing a symbol is within a predefined range.

The method provides a distinct visual indication to the user when the distance between the dataform reader and the symbol is such that the symbol is within the reader's optimal focus zone (i.e. a predefined range) within the broader overall focus zone defined by the dataform reader's full depth of field. The method is useful for handheld dataform readers because the distance between the dataform reader and the surface or object bearing the symbols to be read will vary each time the user points the dataform reader at a symbol.

According to another embodiment, a dataform reader for reading a symbol placed at a distance from the dataform reader is also disclosed. The dataform reader comprises an image capturing device, a targeting image projection component for projecting a targeting image into the dataform reader's scan field, a ranging means for measuring the distance between the dataform reader and the symbol and a processor operably connected to said image capturing device, the targeting image projection component and the ranging component, wherein the processor embodying a computer-readable programming code, such that, when the programming code is executed by the processor, the processor performs the method described herein.

### BRIEF DESCRIPTION OF THE DRAWINGS

The various embodiments of the invention will be described with the aid of the following drawings, in which, like reference numbers represent like elements. The drawings are schematic and features shown therein are not to scale and are not intended to show actual dimensions.

FIG. 1 is a schematic illustration of a dataform reader employing the method of the present disclosure.

FIG. 2 is a schematic illustration of another dataform reader according to another embodiment of the present disclosure.

FIG. 3 is a flow diagram of the method of the present disclosure.

### DETAILED DESCRIPTION

As used herein, the terms “reader” and “scanner” are used interchangeably to refer to a device for reading symbols such as various types of barcodes, PLCs (price look-up-codes), etc. As used herein, the term “dataform” includes all forms of machine readable symbols and arrangements when decoded represents some data. The dataform can be a 1-Dimensional barcode, a 2-Dimensional barcode, a matrix code, a PLC, as well as words, numbers, other symbols or various combinations thereof, which may be printed or etched on a surface.

According to an embodiment of the present disclosure, in an imager type dataform reader, the dataform reader captures a digital image of a dataform presented within the reader's scan field or the field of view and identifies and decodes the dataform. Regardless of the particular symbol the imager reader is reading, because an imager type reader is essentially a digital camera, the symbol presented to the reader in the scan field must be within the reader's optimal depth of field range for the symbol to be in focus at the reader's image capturing device. When the image of the symbol is in focus, the reader's ability to identify and decode the symbol is most effective or optimal.

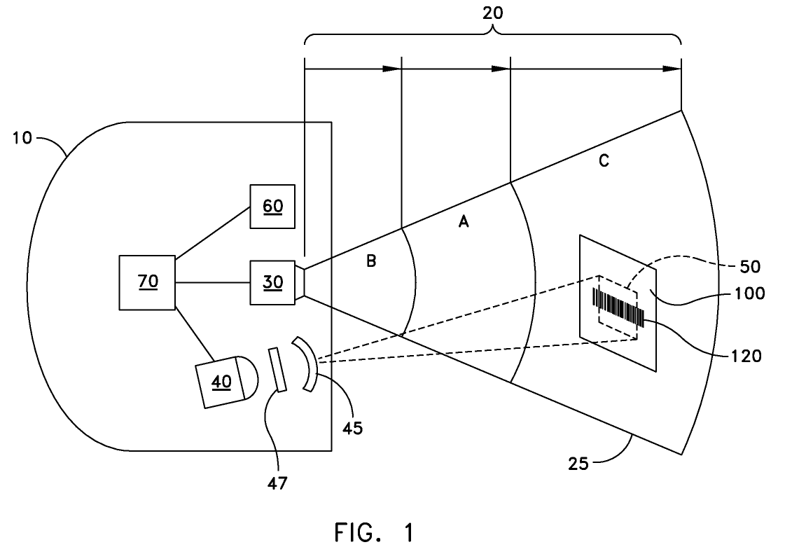

FIG. 1 shows a schematic 2-dimensional view of a dataform reader 10 to aid in the description of the method of the present disclosure. The dataform reader 10 includes among other components, an image capturing device 30, a targeting image projection component 40, a target ranging component 60 and a processor unit 70 for controlling the operation of the dataform reader 10. The processor unit 70 includes the necessary data storage devices (not shown) for storing the programming codes necessary for the operation of the dataform reader 10 such as decoding the information represented by the symbol 120 read by the dataform reader 10.

According to a preferred embodiment, the dataform reader's full depth of field 20 in the reader's field of view 25 (also the scan field) is divided into three regions A, B, C. These regions represent the optimal focus range A, where the dataform reader performs most aggressive and the non-optimal focus ranges B and C, where the dataform reader performs less aggressive. For optimal performance of the dataform reader, the user should be taking a reading when the symbol to be read is within the optimal focus range A.

The dataform reader's targeting image projection component 40 projects a targeting image 50. In one embodiment, the targeting image projection component 40 is an LED and the targeting image 50 is a projection of the illuminating LED die itself projected via a lens 45. Thus, the shape of the targeting image will be the shape of the LED die. Alternatively, the targeting image projection component 40 can be configured and adapted to project a targeting image of any desired shape by providing appropriate filter or screen 47 bearing a desired shape.

In one preferred embodiment, the targeting image projection component 40 is a dual wavelength LED (i.e. Blue/White LED). The duel wavelength LED can emit either wavelength light separately or simultaneously. A user would aim the dataform reader 10 on the symbol 120 by overlapping the targeting image on the symbol 120. The dataform reader's target ranging component 60 constantly monitors the scan field of the dataform reader to measure the distance to an object placed within the dataform reader's scan field. When the target ranging component 60 determines the distance to the surface 100 bearing the symbol 120, the reader's processor unit 70 will cause the LED 40 to change the color of the light being emitted depending on the measured distance to the surface bearing the symbol 120. For example, the dataform reader 10 can be configured so that the LED 40 emits blue light if the distance to the symbol indicates that the symbol is within the optimal focus range A thus projecting a blue colored targeting image 50. Otherwise, the LED 40 will emit white light thus projecting a white colored targeting image 50 by default. Thus, after aiming the dataform reader 10 towards the symbol 120, the user simply has to move the dataform reader 10 and vary the distance between the dataform reader 10 and the symbol 120 until the color of the targeting image is blue. Then, the user can trigger the dataform reader 10 to take a reading. The processor 70 controls the LED 40 to emit the desired wavelength light based on the input the processor receives from the ranging component 60 regarding the distance to the symbol 120. The ranging component 60 provided in a reader can be an infrared emitter/receiver pair or a laser emitter/receiver pair to measure distance to the surface presented within the dataform reader's field-of-view.

Other visual characteristic of the targeting image 50 other than the color used in the above example can be used as an indicator to the user. The shape or the size of the targeting image 50 can be changed from one state to another state as an indicator, for example. Alternatively, more than one of these visual characteristics can be changed to better accommodate a particular application environment. Even after the user becomes trained to know the reader's optimal focus distance, the visual cue provided by the changing of the visual characteristic of the targeting image serves as an efficient confirmation and assurance to the user that the reader is in proper position for taking a reading.

In one embodiment, the dataform reader 10 may be an imager type reader and the image capturing device 30 includes the optical components necessary for capturing a digital image of the symbol 120 (similar to a digital camera) to be decoded by the processor unit 70. In another embodiment, the dataform reader 10 may be a laser scanner barcode reader and the image capturing device 30 includes the optical components and laser scanning components necessary for reading the symbol 120 using a scanning laser beam which is decoded by the processor unit 70.

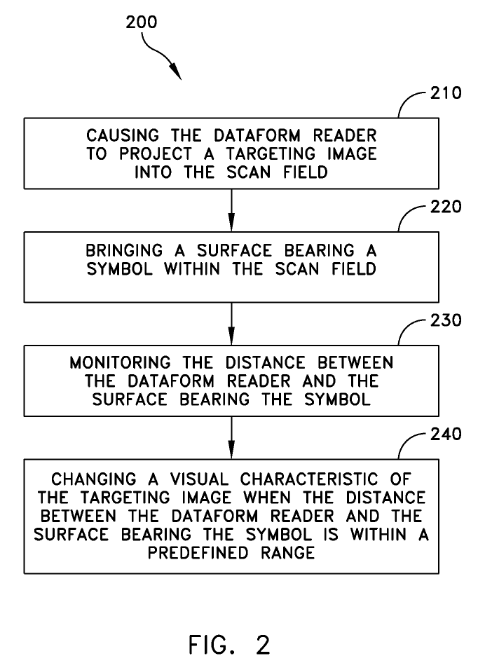

FIG. 2 shows a flow diagram 200 summarizing the method of the present disclosure. The processor 70 of the imager reader 10 causes the imager reader 10 to project a targeting image 50 into the reader's scan field 25 (see block 210). Next, the surface 100 bearing the symbol 120 to be read is brought within the scan field 25 (see block 220). In the meanwhile, the imager reader 10 monitors the distance between the imager reader 10 and the surface 100 bearing the symbol 120 using a distance measuring means 60 provided in the imager reader 10 (see block 230) and a visual characteristic of the targeting image 50 is changed when the distance between the imager reader 10 and the surface 100 bearing the symbol 120 is within a predefined range (see block 240).

While the foregoing invention has been described with reference to the above embodiments, various modifications and changes can be made without departing from the spirit of the invention. Accordingly, all such modifications and changes are considered to be within the scope of the appended claims.

What is claimed is:

1. A method for use with a dataform reader that includes a targeting image projected into the dataform reader's scan field for targeting a symbol to be read, said method comprising:
causing the dataform reader to project said targeting image into the dataform reader's scan field;
bringing a surface bearing a symbol within the scan field, said surface being at a distance from the dataform reader;
monitoring the distance between said dataform reader and said surface bearing the symbol using a ranging means provided in the dataform reader; and
changing a visual characteristic of the targeting image when said distance between the dataform reader and the surface bearing the symbol is within a predefined range.

2. The method of claim 1, wherein changing the visual characteristic of the targeting image involves changing the targeting image's color.

3. The method of claim 1, wherein changing the visual characteristic of the targeting image involves changing the targeting image's shape.

4. The method of claim 1, wherein changing the visual characteristic of the targeting image involves changing the targeting image's size.

5. The method of claim 1, wherein said predefined range is an optimal focus range for the dataform reader.

6. A dataform reader for reading a symbol placed at a distance from the dataform reader, said dataform reader comprising:
an image capturing device;
a targeting image projection component for projecting a targeting image into said dataform reader's scan field;
a ranging means for measuring the distance between the dataform reader and the symbol; and
a processor operably connected to said image capturing device, said targeting image projection component and said ranging component, wherein said processor embodying a computer-readable programming code, such that, when said programming code is executed by the processor, the processor performs a method comprising:
causing the dataform reader to project the targeting image into the dataform reader's scan field;
bringing a surface bearing the symbol within the scan field, said surface being at a distance from the dataform reader;
monitoring the distance between the dataform reader and the surface bearing the symbol using the ranging means provided in the dataform reader; and
changing a visual characteristic of the targeting image when said distance between the dataform reader and the surface bearing the symbol is within a predefined range.

7. The dataform reader of claim 6, wherein changing the visual characteristic of the targeting image involves changing the targeting image's color.

8. The dataform reader of claim 6, wherein changing the visual characteristic of the targeting image involves changing the targeting image's shape.

9. The dataform reader of claim 6, wherein changing the visual characteristic of the targeting image involves changing the targeting image's size.

10. The dataform reader of claim 6, wherein said predefined range is an optimal focus range for the dataform reader.

11. The dataform reader of claim 6, wherein the dataform reader is an imager type reader and said image capturing device comprises optical components necessary for capturing a digital image of the symbol.

12. The dataform reader of claim 6, wherein the dataform reader is a laser scanner barcode reader and said image capturing device comprises optical components and laser scanning components necessary for reading the symbol using a scanning laser beam.
